(19) United States
(12) Patent Application Publication
(10) Pub. No.: US 2019/0279122 A1
(43) Pub. Date: Sep. 12, 2019

(54) SYSTEM FOR OBTAINING AND DISTRIBUTING VALIDATED INFORMATION REGARDING A LIVE PERFORMANCE

(71) Applicant: Muzooka, Inc., Southlake, TX (US)

(72) Inventors: Marc William Lindenbach, NW Calgary (CA); Leigh James McDonald, SE Calgary (CA); Shawn Jeffrey Wilson, SW Calgary (CA)

(73) Assignee: Muzooka, Inc., Southlake, TX (US)

(21) Appl. No.: 16/296,446

(22) Filed: Mar. 8, 2019

Related U.S. Application Data
(60) Provisional application No. 62/641,233, filed on Mar. 9, 2018.

(51) Int. Cl. G06Q 10/02; G06F 16/903; G06F 21/31; G06Q 20/04; G10L 15/22; G10L 15/18

(52) U.S. Cl. CPC G06Q 10/02; G06F 16/90335; G06F 21/31; G06Q 50/01; G10L 15/22; G10L 15/1815; G06Q 20/045

(57) ABSTRACT

Described herein are techniques for obtaining and distributing validated information regarding an event, performed by an artist, to a performing rights organization (PRO). More particularly, described herein are embodiments of a platform that collects validated information regarding a performance by an artist of one or more works registered with a PRO, and distributes that collected information to a PRO to act as a validated source of information regarding a performance. Upon receipt of the validated information from the platform, the PRO may act to distribute royalties to the artist who performed in the performance of the registered work(s). In some embodiments, the platform may permit automated retrieval of validated information regarding a performance, that is to be compiled for submission to the PRO regarding the performance.

### CROSS-REFERENCE TO RELATED APPLICATIONS

The present application claims priority under 35 U.S.C. § 119(e) to U.S. Provisional Patent Application No. 62/641,233, filed Mar. 9, 2018 and titled “System for obtaining and distributing validated information regarding a live performance,” the entire disclosure of which is hereby incorporated herein by reference.

### BACKGROUND

Artists, including musicians, are often compensated for their performances in the form of royalties owed for performances, including live performances, of the artist's works. When an artist plays at a concert at which tickets are sold or other revenue is collected, the artist may be paid in the form of a portion of the revenue.

Performing Rights Organizations (PROs) (also sometimes known as collective management organizations (CMOs)) may be responsible for collecting monies owed to artists for performances and distributing royalties to artists appropriately. An artist may contract with a PRO for all or a portion of the artist's works, which the artist may register with the PRO. Thereafter, the PRO may monitor for performance of the registered work(s) and collect money from venues for the performances. Once the money is collected, the PRO may distribute money to the artist.

### SUMMARY

In one embodiment, there is provided a method of reporting an event, performed by an artist, to a performing rights organization. The method comprises validating that a user is an authorized representative of the artist; receiving, in response to a query of at least one computing device associated with at least one ticketing system, a first set of information characterizing the event, the at least one ticketing system each transacting with attendees of the event to provide tickets to the event, the first set of information comprising a type of event, a venue of the event, at least one ticket price for the event, and an identification of one or more promoters of the event; obtaining, from the user, a second set of information characterizing the performance by the artist at the event, wherein the second set of information comprises an identification of one or more songs performed by the artist at the event; and registering the performance by the artist at the event with the performing rights organization, wherein the registering comprises sending to the performing rights organization the first set of information characterizing the event and the second set of information characterizing the performance by the artist at the event.

In some embodiments, there is provided a method, wherein validating that the user is the authorized representative of the artist comprises obtaining from the user login credentials for an account with a social network from the user and confirming that the social network associates the account with the artist.

In some embodiments, there is provided a method, wherein receiving the first set of information characterizing the event comprises polling the at least one ticketing system at a regular interval for information regarding events for which the at least one ticketing system stores information, the events comprising the event.

In some embodiments, there is provided a method, wherein obtaining the second set of information characterizing the performance by the artist at the event comprises obtaining from at least one second computing device a purported list of the one or more songs performed by the artist at the event, the purported list having been contributed at least in part by attendees of the event, sending a prompt to the user to input the identification of the one or more songs, the prompt comprising the purported list and prompting the user to confirm or edit the purported list.

In some embodiments, there is provided a method, wherein obtaining the second set of information characterizing the performance by the artist at the event comprises presenting, via an automated dialog system, in a dialog with the user, wherein engaging with the dialog with the user comprises prompting the user with a sequence of a plurality of prompts, each prompt of the plurality of prompts prompting the user to input information regarding the event; and in response to each prompt of the plurality of prompts, interpreting input from the user in response to the prompt.

In some embodiments, there is provided a method, wherein engaging in the dialog comprises engaging in a dialog that is at least partially text-based, and wherein interpreting the input comprises performing natural language processing on input provided by the user.

In some embodiments, there is provided a method, wherein engaging in the dialog comprises engaging in a dialog that is at least partially speech-based, and wherein interpreting the input comprises performing automatic speech recognition (ASR) on speech input provided by the user.

In some embodiments, there is provided a method, wherein prompting the user with the sequence of the plurality of prompts comprises presenting at least one prompt that requests the user to select one option from among a plurality of presented options and interpreting the input comprises interpreting the input to determine which option from among the plurality of presented options was selected by the user.

In some embodiments, there is provided a method, wherein prompting the user with the sequence of the plurality of prompts comprises presenting at least one prompt comprises prompting the user based on the first set of information characterizing the event.

In some embodiments, there is provided a method, wherein prompting the user based on the first set of information characterizing the event comprises, in response to receiving a request from the user to report an event, determining one or more artists for which the user has been validated as representative, determining one or more events in which information from the at least one ticketing system indicates the artist is performing, will perform, or performed, the one or more events including the event, prompting the user to select an event from among the one or more events that the user is to report to the performing rights organization, in response to selection by the user of the event, prompting the user to input the second set of information characterizing the performance.

In some embodiments, there is provided a method, wherein prompting the user to input the second set of information characterizing the performance comprises determining one or more previously-performed songs performed by the artist at one or more prior events and prompting the user to input the one or more songs at least in part by selecting the one or more songs performed by the artist at the event from among a list of the one or more previously-performed songs.

In some embodiments, there is provided a method, wherein prompting the user to input the second set of information characterizing the performance comprises determining one or more registered songs of the artist registered with the performing rights organization and prompting the user to input the one or more songs at least in part by selecting the one or more songs performed by the artist at the event from among a list of the one or more registered songs.

In some embodiments, there is provided a method comprising in response to determining that at least some of the one or more songs performed by the artist at the event are registered with a second performing rights organization, additionally registering the performance by the artist at the event with the second performing rights organization, wherein the registering comprises sending to the second performing rights organization at least some of the first set of information characterizing the event and at least some of the second set of information characterizing the performance by the artist at the event.

In another embodiment, there is provided at least one non-transitory computer-readable storage medium. The at least one non-transitory computer-readable storage medium is encoded with executable instructions that, when executed by at least one processor, cause the at least one processor to carry out the method of any one or any combination of the foregoing embodiments.

In a further embodiment, there is provided an apparatus. The apparatus comprises at least one processor and at least one computer-readable storage medium encoded with executable instructions that, when executed by the at least one processor, cause the at least one processor to carry out the method of any one or any combination of the foregoing embodiments.

### BRIEF DESCRIPTION OF DRAWINGS

In the drawings:

FIG. 1 shows an illustrative system for reporting an event, performed by an artist, to a performing rights organization.

FIG. 2 illustrates an example process flow for reporting an event, performed by an artist, to a performing rights organization.

FIG. 3 illustrates an example process flow for validating that a user is an authorized representative of an artist.

FIG. 4 illustrates an example process flow for obtaining, from at least one ticketing system, information characterizing an event.

FIG. 5 illustrates an example process flow for obtaining, from a user, information characterizing a performance by an artist at an event.

FIG. 6 illustrates an example process flow for registering a performance by an artist at an event with a performing rights organization.

FIGS. 7A-7E illustrate example logic flow charts for communicating with a user via a messaging application to obtain information characterizing a performance by an artist at an event.

FIG. 8 illustrates an embodiment of a computing device as described herein, for example for reporting an event, performed by an artist, to a performing rights organization.

### DETAILED DESCRIPTION

Described herein are techniques for obtaining and distributing validated information regarding an event, performed by an artist, to a performing rights organization (PRO). More particularly, described herein are embodiments of a digital platform that automatically collects validated information regarding a performance by an artist of one or more works registered with a PRO, and distributes that collected information to a PRO to act as a validated source of information regarding a performance. Upon receipt of the validated information from the platform, the PRO may act to distribute royalties to the artist who performed in the performance of the registered work(s). In some embodiments, the platform may permit automated retrieval of validated information regarding a performance, that is to be compiled for submission to the PRO regarding the performance. For example, such validated information may include validated information characterizing an event at which the performance occurred, such as characterizing a type of the event, a venue of the event, and/or information on ticket sales for the event. In some embodiments, the platform may additionally or alternatively retrieve validated information on an identity of a user, such as an identity of a user who is an artist or who is a representative of the artist. Such identity information may be retrieved from a validated source of identity information, including a trusted platform with which the artist and/or the artist's representatives interact and that has identified an artist or an artist's representatives. Having validated an identity of the user, the platform may additionally interact with a validated user to obtain information characterizing a performance, such as information identifying one or more registered works performed by the artist in the performance. The platform may additionally or alternatively permit automated retrieval from a PRO of registered works of the artist. In some such embodiments, the platform may use the list of registered works to prompt a user to identify which of the registered works were performed by the artist in the performance. With emphasis placed, in some embodiments, on receiving validated information from one or more sources, the platform may interact with a user in some such embodiments using a streamlined user interface, which merely triggers collection of validated information from other sources and prompts a user for information to be collected from the (validated) user. Such prompts may, in some embodiments, be based on the validated information previously retrieved by the platform and provide options for the user to select from among the validated information, both to constrain the interaction to only validated information and to provide an automated workflow for collection of information regarding a performance. In some embodiments, the automated workflow may advantageously be in the form of an automated dialog system, such as a “chatbot” or other messaging client. In other embodiments, the automated workflow may be in the form of a webpage interface.

The system of these embodiments, including the platform that collects and distributes validated information, provides a specific approach to collection and distribution of information regarding performances and registration of performances, that may address and/or eliminate difficulties that have plagued the entertainment industry for nearly 150 years, when PROs were first created to address these difficulties. Such difficulties persist and have become more widespread over recent decades, as the size and scale of the entertainment industry has grown. These difficulties surround ensuring PROs can obtain accurate and complete information regarding performances, and most importantly, can properly distribute royalties appropriately to artists that earned the royalties. Such proper distribution is not happening today.

As discussed above, performing rights organizations (PROs) provide intermediary functions, particularly collection of royalties, between copyright holders and parties who wish to use copyrighted works publicly (e.g., a radio station airing a song or a band playing at a live venue). In the context of an artist performing a show, the PRO is responsible for collecting royalties (e.g., ticket revenue) and distributing appropriate royalties to the artist.

In many cases, an artist may be owed royalties for a performance by another artist, such as when one artist “covers” the work of another and the original artist is to be compensated for the “cover” performance. While, for ease of description, many examples below are described in the context of collecting information about a performance by an artist for distribution of royalties to that same artist, it should be appreciated that embodiments are not so limited and that royalties may be distributed to any suitable recipient based on information collected using techniques described herein. Those skilled in the art will understand that royalties are owed to rights holders in songs, which may include the performing artist when the performing artist is the original composer, but may additionally or alternatively include other artists.

For a PRO to properly distribute royalties to an artist for a show performed by the artist, the PRO first collects various information relating to the artist and to the show, either through its own collection efforts (typically reserved for a PRO's biggest artists) or collection via registration of performances by artists. For example, the information that the PRO may collect might include: the location of the event, the name of the venue, the type of venue (e.g., festival, pop-up concert), the type of event, the price of a ticket, the number of tickets sold, the artists playing at the show, the order of the lineup in the show (e.g., which artists headlined an event, and which artist opened for the headliners, as headlining artists may receive more royalties in some situations), the work(s) that each artist performed, the date and time of the show, gross ticket sales, information about a promoter of the event (e.g., address, phone number), physical proof of a ticket (e.g., a picture of a ticket stub), and artists' contracts.

Conventionally, a PRO typically receives this information by receiving a royalty request from an artist or a representative of the artist. The royalty request may be in the form of a paper form that the artist or representative completes to provide some or all of the information described above. In some cases, the royalty request may not include all of the information that the PRO may use to distribute royalties, such as when the PRO's royalty distribution process relies on information that may not be available to the artist or artist's representative (e.g., some information regarding a venue or a promoter of an event). Such a royalty request may prompt the PRO to do further research and collect additional information before royalties may be distributed. There may be a significant amount of work and time involved for the PRO to properly register a performance by an artist at an event, and to properly distribute royalties. Because of the difficulties in verifying all the information, PROs often do not have sufficient resources to properly validate all performances for which registrations are received. Royalties may not be distributed for registrations that are not validated. As a result, only performances for the biggest artists are validated, and only the biggest artists and the biggest shows are properly verified and lead to proper distribution of royalties. This results in smaller artists not receiving the resources they earned.

Beyond these difficulties in collection of information, a significant and longstanding problem with conventional methods for performance registration is a lack of validation of the information that the PRO receives in a royalty request. Because of this lack of validation, PROs are often subject to fraud. For example, an individual could attempt to impersonate an artist and submit a royalty request to a PRO, when that individual did not perform and is not owed royalties. In some cases, some individuals may even succeed in receiving payments. Because a substantial fraction of performance registrations received by PROs are fraudulent, PROs must devote resources to weeding out fraudulent submissions (taking resources away from processing proper submissions), and thus invest a great deal of time in determining the accuracy of submissions. As such, PROs spend significant time attempting to validate information that they receive in royalty requests. For example, the PRO may attempt to contact the listed venue to confirm that an artist played at a show. The PRO may also attempt to contact the artist or a representative of the artist to confirm that they are aware of the royalty request that the PRO received. Due to limited availability of information about a performance, or limited time or other resources on the part of the PRO, such verification efforts by the PRO may not always end with an artist being properly compensated.

Due to these difficulties, at best, there may be significant delay between when an artist or artist's representative sends a royalty request and when the artist receives appropriate royalties, and at worst, an artist may never be paid or may be paid only a fraction of what they are owed.

This is a substantial and ongoing problem in the entertainment industry. PROs invest huge resources in working with larger concerts and larger events (e.g., multi-day concerts with thousands of attendees) and even invest resources in trying to track down performances in medium-sized or smaller venues, but PROs do not collect funds for many performances for which artists are owed royalties. Worse, even in many cases in which PROs collect funds for performances, despite best efforts of PROs to obtain information about performances, and despite best efforts of artists to register their performances, artists may not be fully compensated. Industry experts estimate that while each year there may be as much as $500 million in the U.S., and as much as $1 billion globally, that is owed to artists for performances, less than $20 million—a substantially small fraction—may be properly distributed to artists owed royalties. The rest may be held by the PROs for deserving artists, and the PROs try to determine to whom to distribute the funds, but the PROs are often unable to make payments without proper proof of which artists are owed. Thus, there is hundreds of millions of dollars per year owed to artists and not paid (including proverbial “starving artists”), and potentially billions of dollars owed to artists for performances just over the past decade, not to mention prior decades.

This is a well-known and oft-discussed problem in the entertainment industry, and the industry has struggled with this problem for over a century—it was a driving force behind the original creation of PROs in the mid-19th century. Particularly over recent decades, the industry has tried repeatedly, with numerous different approaches to the problem, to adopt new methods for collecting information on performances, to try to better and more accurately distribute royalties to deserving artists. Many recent efforts include techniques at electronic submission of information. Despite the huge effort invested by many parties across the industry, each such effort has been unsuccessful, and the billion-dollar problem persists in the industry and is worsening as the industry grows.

The inventors have recognized and appreciated that these significant and substantial challenges involved in the distribution of royalties may be mitigated by a system that provides for obtaining and distributing validated information, including by obtaining information from particular validated sources of that information. Repeated, conventional efforts on the part of the industry to collect more and better information have focused on collecting information from artists or artist's representatives, but all eventually faced the same impediments with respect to availability of information and, more importantly, trustworthiness of the submitted information and distinguishing fraudulent from correct submissions. The inventors recognized and appreciated, however, that obtaining limited information from artists or artists' representatives may be a more viable path, particularly when combined with validation for users who purport to be an artist or an artist's representative and when combined with a streamlined, automated workflow for collecting information from such a user and triggering collection from other validated sources. More particularly, the inventors have identified specific combinations of sources of information, each of which may provide specific types of information that may be used by a PRO to register a performance and distribute royalties. Each of these sources may be individually validated and, as such, when the specific type(s) of information regarding a performance are obtained from each of these specific sources, the information may be validated. Accordingly, by obtaining specific types of information regarding a performance for a PRO from a particular combination of sources, and by validating those sources to ensure the information that is collected is accurate and reliable, an overall set of validated information regarding a performance may be generated.

The specific sources of information regarding a performance, which may be validated and from which validated information may be obtained, may include sources of identity information for users, sources of ticketing or venue information for a performance, and sources of registered works for an artist.

For example, in some embodiments, users of a performance registration system, who may be artists or artists' representatives, may additionally interact with one or more other systems external to the performance registration system and, in those interactions with external systems, may provide their identity as artists or representatives of artists and be validated by those external systems. Such a system may include a social network that distributes information by and about artists. The social network may validate users as being either artists for which information is distributed, or as representatives of artists who may adjust the information by and about the artist on behalf of the artist. In some embodiments, a platform described herein for obtaining validated information may retrieve from such a social network an identification of users who have already been validated by that social network as acting on behalf of a particular artist. Some such social networks may identify, for a user identified in the social network as a representative, one or multiple artists of whom the user has been validated as a representative. In some such embodiments, the system may only permit a user to interact with the user on behalf of an artist (i.e., as an artist's representative) when that user was previously validated by that social network as acting on behalf of that particular artist. The user may then only provide information to the performance registration system regarding a performance of the artist when the user has been identified by the social network as a representative of that artist. In this manner, the system may limit who may claim to be acting on behalf of an artist and may thereby fraudulent submissions, increasing reliability and trustworthiness of information.

As another example, in some embodiments an event at which an artist may perform may be registered with a ticketing system that is external to the performance registration system. The ticketing system may interact with attendees of an event to sell tickets to the event. In that context, the ticketing system may store information characterizing the event, such as information including a type of event, a venue of the event, an identity of one or more artists performing at the event, at least one ticket price for the event, and an identification of one or more promoters of the event. Such a ticketing system may be hired by the venue and/or the promoter of the event to sell tickets on its behalf, and is thus trusted by the venue/promoter. Attendees also purchase tickets from that ticketing system, and thus it is trusted by the attendees. In some embodiments, a performance registration system may leverage that pre-existing trust to obtain information regarding the event from the ticketing system, including information that a PRO may request as part of determining whether and how to distribute royalties. Some of this information may be information that may be otherwise difficult for an artist or an artist's representative to obtain, or that may need to be validate (and that may be difficult to validate) if provided by the artist or artist's representative as in conventional approaches. The inventors recognized and appreciated that by retrieving this information from a validated ticketing system, rather than from a user, reliability and trustworthiness of the information may be increased, and fraudulent submissions may be decreased.

As discussed below, while some performances may occur at events for which a ticketing system stores information and collects funds from attendees, this is not true of all performances. Some informal performances, or less formal performances, may not be registered with a ticketing system or otherwise may not have information stored in a ticketing system. In such cases, as discussed below, a performance registration system may not retrieve information characterizing the event from a ticketing system.

As another example, in some embodiments a PRO may maintain a data store storing information on works of an artist that have been registered with an artist (or a representative of the artist) with the PRO. For example, where such works are songs, the PRO may maintain in the data store a list of songs by an artist that have been registered with the PRO. In some cases, artists may register different of their works with different PROs, and thus work with different PROs for receipt of royalties for performances of different works (e.g., a different PRO for songs on different albums, or any other division of songs). In some embodiments, a performance registration system may collect from PROs the different works registered by an artist with the PROs. The system may then interact with users regarding performances by an artist, and only permit submission of information regarding a performance of a work that has been previously registered. In this manner, reliability and trustworthiness of the information may be increased, and fraudulent submissions may be decreased. Moreover, by identifying the different PROs with which different works of an artist may be registered, when a user (e.g., an artist or representative) submits information to register a performance by an artist of multiple works, the performance registration system may then distribute information regarding performances of different works to different PROs, directing the information to the appropriate PRO and mitigating risk of duplication of requests or sending requests to the wrong PRO.

The inventors further recognized and appreciated the advantages of a particular streamlined user interface to interact with users regarding registration of a performance, where the users themselves may be validated using information retrieved from one or more of the validated sources, as discussed above. While conventional approaches focused on collecting a diverse range of information from users, in some embodiments, techniques described herein may collect only limited and specific information from a user, instead using the interface to trigger and drive interactions with other validated sources and interact with a user regarding specific information that was previously obtained from the other validated sources. For example, in some embodiments, a user interface may prompt a user for information to be collected from a (validated) user. Such prompts may, in some embodiments, be based on validated information previously retrieved by the platform and provide options for the user to select from among the validated information, both to constrain the interaction to only validated information and to provide an automated workflow for collection of information regarding a performance. For example, when a user who is a representative indicates that the user would like to register a performance, the performance registration system may prompt the user for which artist the user is submitting a registration for, and the list of artists may be constrained to only those artists the social network or other identity validation system indicated the user validly represents. As another example, when the user has indicated that the user is registering a performance by an artist, the system may prompt the user to select a recent performance by the artist, and the list of recent performances may be constrained to events in which the ticketing system identified the artist performed. As a further example, when the user has indicated that the user is registering a performance by an artist at a particular event, the user may be prompted to select which works the artist performed, and the list of works may be constrained to the works of the artist that were identified as registered in the data store(s) of one or more PROs.

In this manner, the user may be validated before receipt of any information from the user, and the user may be constrained to providing only information validated by one or more other systems that were themselves validated. The performance registration system may, in this way, ensure that only validated information from validated sources is provided to a PRO in a request to register a performance and collect royalties for a performance. In addition, in some embodiments, the system may interact with the user in the form of an automated workflow such as an automated dialog system, such as a “chatbot” or other messaging client. This may provide a streamlined, simple interface for a user while also constraining inputs to only validated information. In this manner, some embodiments may address or mitigate both the ongoing and substantial fraud difficulty faced by the entertainment industry with respect to registration of performances. The automated workflow that prompts a user for particular information, and obtains other information from other validated sources, may also increase the comprehensiveness of information a PRO receives in a royalty registration request, reducing or potentially eliminating work a PRO would perform with conventional systems to collect additional information to complete a performance registration request.

Accordingly, described herein are various embodiments of a system for streamlining the process of obtaining information regarding a performance and providing that information to a PRO to register the performance and prompt proper royalty distribution by the PRO. While specific embodiments are described in connection with figures below, it should be appreciated that the described embodiments are merely illustrative, and that other embodiments are possible. Embodiments are not limited to operating in accordance with the specific examples described herein.

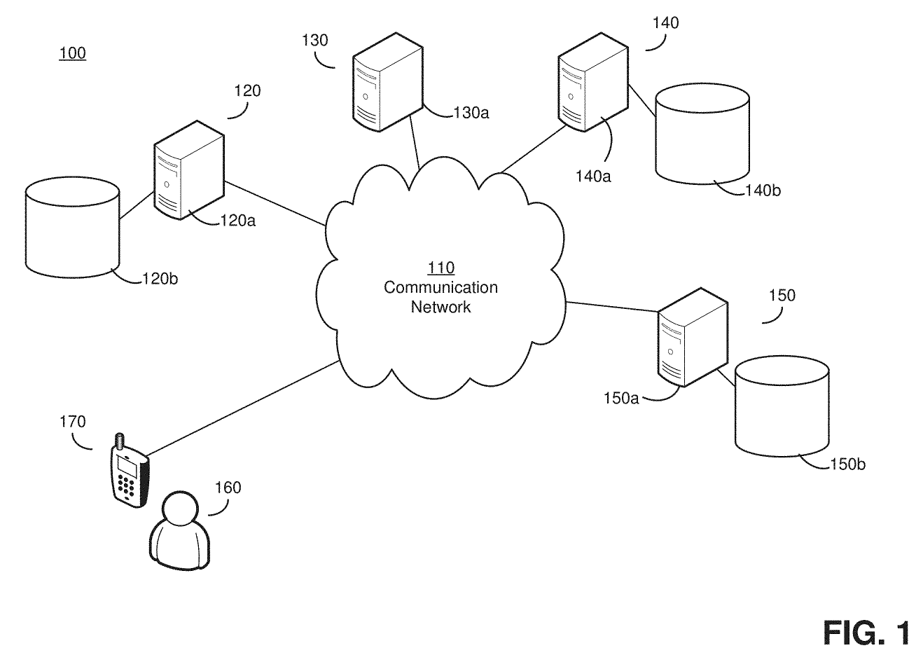

FIG. 1 shows an illustrative system 100 for reporting an event, performed by an artist, to a PRO. The system 100 may include a communication network 110, at least one performance registration system 120, at least one messaging system 130, at least one ticketing system 140, at least one PRO system 150, at least one user 160, and at least one communication device 170. The at least one performance registration system 120 may include at least one computing device 120a and at least one data store 120b, the at least one messaging system 130 may include at least one computing device 130a, the at least one ticketing system 140 may include at least one computing device 140a and at least one data store 140b, and the at least one PRO system 150 may include at least one computing device 150a and at least one data store 150b. The at least one user 160 may be an artist, or may be a representative of the artist. In some embodiments, the at least one communication device 170 may be a mobile device (e.g., a phone). The at least one performance registration system 120, the at least one messaging system 130, the at least one ticketing system 140, the at least one PRO system 150, and the at least one communication device 170 (through which the at least one user 160 communicates) may be configured to communicate over the communication network 110, which may be any suitable one or more wired and/or wireless, local- and/or wide-area network, including the Internet.

In the illustrative system 100, the at least one performance registration system 120 may be configured to facilitate a process by which an event (e.g., a show at which the at least one user 160, or at which an artist that the at least one user 160 represents, performed) is reported to a PRO (associated with the at least one PRO system 150) to request royalties.

In some embodiments, the at least one ticketing system 140 may be associated with a ticket sales and distribution company, for example Ticketmaster®, TicketFront™, or Eventbrite®. The at least one ticketing system 140 may be configured to transact with attendees of an event at which an artist performed to provide tickets to the event, and to store, in data store 140b, information characterizing the event. For example, the at least one ticketing system 140 may be configured to store, including in the data store 140b, at least: a location of the event, a date of the event, a time of the event, a type of venue at which the artist performed (e.g., a festival or a pop-up concert), a type of the event, a price of a ticket to the event, a number of tickets sold, gross ticket sales, which artists are performing at the event, the order in which the artists performed (e.g., which artist headlined, and which artist(s) opened for the headliner), a full set list including all works performed by the artists and other artists who originally created or contributed to such works (e.g., composers of songs), information regarding a promoter of the event (e.g., identity of the promoter, address and phone number of the promoter), contracts for each artist, physical proof of the ticket (e.g., a picture of a ticket stub), as well as other information.

The at least one performance registration system 120 may be configured to communicate with the at least one ticketing system 140 to obtain information characterizing an event. The information characterizing the event may include some or all of the information stored in the data store 140b of the at least one ticketing system 140 as described above. In some embodiments, the at least one performance registration system 120 may query the at least one computing device 140a of the at least one ticketing system 140 to provide the information characterizing the event. In response to the query, the at least one performance registration system 120 may receive the information characterizing the event.

In some embodiments, the at least one performance registration system 120 may individually query the at least one computing device 140a of the at least one ticketing system 140 for each specific event for which information is to be obtained. In some such cases, the query may be submitted in response to receipt of some information regarding the event, such as receipt of information from a user 160 or other source. In other embodiments, the at least one performance registration system 120 may query the at least one computing device 140a of the at least one ticketing system 140 to determine information on multiple events in each query. Such a query may be sent to device 140a by the system 120 periodically (e.g., at a predetermined interval or frequency) or occasionally, such as in response to an event. For example, system 120 may query device 140a at a fixed interval or at a fixed time, such as at a same time every day (e.g., every day at midnight), to update information characterizing events for which the system 120 already stores information and/or to receive information regarding events for which the system 140 stores information but for which the system 120 does not yet store information. In some such embodiments, the system 120 may send a query to the system 140 requesting information characterizing events for every artist for which information characterizing events is available from the at least one ticketing system 140. In some other embodiments, the system 120 may sent to the system 140 a query requesting information characterizing events only for artists associated or registered with the at least one performance registration system 120, or for other particular artists, in which case the query from the system 120 may specify artists in a manner in which the system 140 is adapted to receive artist names.

In some embodiments, the system 120 may store an association of users (e.g., user 160) with artists, such as by identifying when a user is an artists or when a user is a manager or other representative for an artist. The system 120 may also, in some embodiments, store an association between known events (e.g., past and/or future events) and artists. For example, when the system 120 obtains, such as in response to a query of the system 140, that an artist is to perform at an event, then the system 120 may store an association between the artist and the event. In addition, in embodiments in which the system 120 stores an association between users and artists, the system 120 may store an association between a user and an event, such as when the user is associated with an artist and that artist is associated with an event. Accordingly, in some embodiments, when the system 120 obtains information on one or more events from the system 140, the system 120 may store the information on the one or more events and may analyze the information on the one or more events, including to create and store associations between one or more users, one or more artists, and one or more events, or between other pieces of information. Accordingly, in some embodiments, when the at least one performance registration system 120 receives information characterizing events, the at least one performance registration system may determine that a user is associated with an event. Such associations may be stored by the system 120 in various ways, depending on a nature of the data store of the system 120. For example, the association may be created by storing the related information in a same row of a database table, when the data store is a relational database. As another example, the association may be created by linking together database tables by a common value, such as a key. It should be appreciated, however, embodiments are not limited to creating and storing all such associations, and that in some embodiments, such associations may be determined dynamically, when information is retrieved and analyzed subsequently in response to a request from a user.

The at least one performance registration system 120 may be configured to communicate with the at least one ticketing system 140 according to an API of the at least one ticketing system 140. When the at least one performance registration system 120 receives the information characterizing the event from the at least one ticketing system 140, the information characterizing the event may be in a format specific to the at least one ticketing system 140. For example, different ticketing systems associated with different ticket sales and distribution companies (e.g., Ticketmaster® and Eventbrite®) may send information to the at least one performance registration system 120 in different formats. The at least one performance registration system 120 may be configured to receive the information characterizing the event in a plurality of formats and to extract relevant information. In some embodiments, the at least one performance registration system 120 may receive the information characterizing the event from the at least one ticketing system 140 before the event occurs. In other embodiments, the at least one performance registration system 120 may receive the information characterizing the event from the at least one ticketing system 140 during the event or after the event occurs. In some embodiments, the at least one performance registration system 120 may receive a first subset of the information characterizing the event from the at least one ticketing system 140 before the event occurs and receive a second subset of the information characterizing the event from the at least one ticketing system 140 during the event or after the event occurs. For example, changes in lineups, changes in ticket prices, or other additions or modifications of information before or after an event or after the event (e.g., if information is removed from the at least one ticketing system 140 after a performance) may be conditions with which the system 140 is configured, that cause the system 140 to communicate with the system 120. For example, the system 140 may send subsets of updated information to the system 120 or send a notification of update to the system 120, which may prompt the system 120 to obtain the updated information or other subset of information.

In some embodiments, the at least one performance registration system 120 may be configured to automatically query the at least one computing device 140a of the at least one ticketing system 140 for the information characterizing the event, and to automatically receive the information characterizing the event. In some embodiments, the at least one performance registration system 120 may be configured to detect if an error occurred during this process. For example, the at least one performance registration system 120 may be configured to determine if the information characterizing the event received from the at least one ticketing system 140 is missing a required piece of information. In such an example, the at least one performance registration system 120 may be configured to send a notification to the at least one ticketing system 140 indicating that the error occurred. In some embodiments, the at least one performance registration system 120 may be configured to send a notification to the at least one ticketing system 140 that the ticket company, associated with the at least one ticketing system 140, must manually submit the information characterizing the event.

In examples above, information regarding an event may be obtained from a service that artists, venues, or other planners of an event may use to generate information regarding an event. Such a service may be trusted as a validated service because the artists, venues, or other planners are using the service. In some other cases, sources of validated information may be services to which event attendees (e.g., an artist's fans) use to submit information regarding an event. For example, in some embodiments, the at least one performance registration system may additionally or alternatively obtain information regarding an event from a crowdsourcing service (e.g., SETLIST.FM or other service) to determine information characterizing the event. Such a service may be trusted as a validated source of information because it curates a number of different submissions, relying on large numbers of users to increase accuracy of the available information for an event. In some such embodiments, the system 120 may obtain from such a crowdsourcing service a setlist (e.g., list of songs performed by an artist) for an event. Some such crowdsourced setlist services may prompt users to enter a setlist or approve or correct a previously-stored setlist, and may upon request from system 120 provide that setlist. The system 120 may store the setlist as information regarding an event, for use by the system 120 including in connection with techniques described below. For example, in some such embodiments, the system 120 may prompt a user 160 to enter a setlist as part of registering for compensation for an artist for performing at an event, and may present the crowdsourced setlist to the user as at least an initial default option for the user, which may ease an input burden on the user. In embodiments that present such a crowdsourced setlist, the user may be presented with an option to edit the crowdsourced setlist prior to submission of the compensation request, such as if the user determines that there are errors or omissions in the crowdsourced setlist.

In some embodiments, the at least one communication device 170 may be configured to allow the at least one user 160 to communicate with the at least one performance registration system 120. In some embodiments, the at least one communication device 170 may be configured to allow the at least one user 160 to communicate with the at least one performance registration system 120 through the at least one messaging system 130. In some embodiments, there may be at least one messaging application, associated with the at least one messaging system 130, on the at least one communication device 170 through which the at least one user 160 may communicate with the at least one performance registration system 120. For example, the at least messaging application may be a messaging application already present on the at least one communication device 170 (e.g., a Facebook® Messenger application, a text messaging application (e.g., using an SMS and/or MMS protocol), or other application). In this example, such a messaging application may make communicating with the at least one performance registration system 120 more convenient for the at least one user 160, as the at least one user 160 may not have to download an additional application to communicate with the at least one performance registration system 120.

In some embodiments, the at least one performance registration system 120 may be configured to send a prompt to the at least one user 160, prompting the at least one user 160 to provide information characterizing a performance by an artist (i.e., the at least one user 160 or an artist that the at least one user 160 represents). In some embodiments, the at least one performance registration system 120 may send the prompt through the at least one messaging system 130 to the at least one messaging application on the at least one communication device 170. The at least one communication device 170 may be configured to display the prompt to the at least one user 160. In some embodiments, a prompt may be provided to the at least one user 160 in response to determining that an event is associated with the at least one user (e.g., if a new event is associated with an artist, and the artist with the user).

The at least one communication device 170 may be configured to allow the user 160 to provide the information characterizing the performance by the artist. In some embodiments, the information characterizing the performance by the artist may include works that were performed by the artist at the event (e.g., a setlist). In some embodiments, the at least one communication device 170 may be configured to display a list of some or all of the artist's works, and further configured to allow the at least one user 160 to select the works that were performed by the artist at the event. In some embodiments, the at least one communication device 170 may be configured to display the list of some or all of the artist's works and allow the at least one user 160 to select the works that were performed by the artist at the event, all within the at least one messaging application on the at least one communication device 170. For example, in an embodiment where the at least one messaging application is Facebook® Messenger, the at least one user 160 may receive a notification on the communication device 170 that they have received a message through Facebook® Messenger, wherein the message indicates that the at least one user 160 is prompted to provide the information characterizing the performance by the artist. The at least one communication device 170 may then, within Facebook® Messenger, display the list of all of the artist's works and allow the at least one user 160 to select the works that were performed by the artist at the event.

In some embodiments, the at least one performance registration system 120 may be configured to send the prompt to the at least one user 160, prompting the at least one user 160 to provide the information characterizing the performance by the artist, after the event has occurred. For example, in some embodiments, the at least one performance registration system 120 may be configured to send the prompt to the at least one user 160 a certain number of hours after the event (e.g., 12 hours after the event), or to send the prompt to the at least one user 160 at a certain time of day (e.g., at LOAM the day after the event).

While the at least one messaging system 130 is shown in FIG. 1 as being a system external to the at least one performance registration system 120, it should be appreciated that the at least one messaging system 130 may be incorporated in the at least one performance registration system 120. For example, the at least one performance registration system 120 may include at least one messaging system 130, and the at least one user 160 may communicate with the at least one performance registration system 120 via a messaging application, on the at least one communication device 170, that is associated with the at least one performance registration system 120.

In this way, the at least one performance registration system 120 may be configured to receive, from the at least one ticketing system 140, the information characterizing the event and to receive, from the at least one user 160, the information characterizing the performance by the artist.

In some embodiments, the at least one performance registration system 120 may be configured to communicate with the at least one PRO system 150 to register the performance by the artist at the event with a PRO associated with the at least one PRO system 150. In some embodiments, the at least one performance registration system 120 may be configured to send the information characterizing the event and the information characterizing the performance by the artist to the at least one PRO system 150 to register the performance by the artist at the event. The at least one performance registration system 120 may be configured to organize the information characterizing the event and the information characterizing the performance by the artist in a format that is recognizable by the at least one PRO system 150.

The at least one performance registration system 120 may be configured to communicate with the at least one PRO system 150 according to an API of the at least one PRO system 150. When the at least one performance registration system 120 sends the information characterizing the event and the information characterizing the performance by the artist to the at least one PRO system 150, the at least one PRO system 150 may expect the information characterizing the event and the information characterizing the performance by the artist in different formats. For example, different PROs (e.g., BMI, ASCAP, SESAC, etc.) may expect the information characterizing the event and the information characterizing the performance by the artist in various formats. The at least one performance registration system 120 may be configured to send the information characterizing the event and the information characterizing the performance by the artist in a plurality of formats, and configured to send the information characterizing the event and the information characterizing the performance by the artist in a format appropriate for the specific PRO associated with the at least one PRO system 150.

In some embodiments, the PRO associated with the at least one PRO system 150 may not require submission of the information described above as information characterizing the event for a performance by an artist to be reported, or may permit for submission of limited information characterizing the event. The information that may not be required may include information on a ticket price, or a venue, or a promoter, or other information characterizing an event. This may permit for submission of information regarding less formal events, such as events that do not have a promoter or venue, including informal events such as ad hoc performances on parks or sidewalks or similarly informal events and/or events to which tickets were not sold. In the case of such an informal event, a ticketing system may not store information on the event, because tickets were not sold, and there may not be any information available about a promoter because there was no promoter. Regardless, an artist may be owed royalties for the performance. Thus, in some embodiments, such as depending on a type of an event, the at least one performance registration system 120 may not need to query and obtain the information characterizing the event from the at least one ticketing system 140, and may be configured to send only the information characterizing the performance by the artist to the at least one PRO system 150. By doing so, the at least one performance registration system 120 may allow the at least one user 160 to request royalties from a PRO for a show without the show being paid/ticketed.

In this way, the at least one performance registration system 120 may facilitate the process by which the PRO receives royalty requests. This may expedite the process of registering a performance by an artist at an event, and distributing appropriate royalties, as the PRO is ensured that the at least one performance registration system 120 provided all information required to register the performance by the artist at the event. Furthermore, the at least one performance registration system 120 may assist the PRO in validating the information required to register the performance by the artist at the event. For example, the at least one performance registration system 120 may be able to ensure the PRO that the information characterizing the event and the information characterizing the performance by the artist is validated.

Regarding the information characterizing the event, the at least one performance registration system 120 may be able to ensure this information is validated because it is being received directly from the at least one ticketing system 140. As the at least one ticketing system 140 is associated with at least one ticket sales and distribution company (e.g. Ticketmaster® or Eventbrite®), the at least one performance registration system 120 may be able to confirm to the PRO that the information characterizing the event is validated. In some embodiments, the at least one performance registration system 120 may, before receiving the information characterizing the event from the at least one ticketing system 140, validate if the at least one ticketing system 140 associated with at least one ticket sales and distribution company is legitimate, and is actually associated with the at least one ticket sales and distribution company.

Regarding the information characterizing the performance by the artist, the at least one performance registration system 120 may be able to ensure this information is validated at least by confirming that the at least one user 160 is the artist, or is a representative of the artist. In some embodiments, there may exist an enrollment process by which the at least one performance registration system 120 validates the identity of the at least one user 160. For example, in some embodiments, the at least one user 160 may have created an artist profile during the enrollment process. The artist profile may, for example, be a profile on Facebook®, or may be a profile associated with the at least one performance registration system 120 (e.g., on Muzooka.com). While creating the artist profile, the at least one user 160 may have provided identification information to validate that the at least one user 160 is the artist or is the representative of the artist. For example, the at least one user 160 may provide at least one email address, at least one phone number, and/or other identification information, and the at least one user 160 may have been contacted to confirm that the at least one user 160 is the artist or is the representative of the artist.

In this way, the PRO may be ensured that the information characterizing the event, obtained from the at least one ticketing system 140 by the at least one performance registration system 120, and the information characterizing the performance by the artist, provided by the at least one user 160 to the at least one performance registration system 120, is validated. This may save significant time that may otherwise be spent by the PRO in validating that a royalty request is legitimate, which may help in appropriately distributing royalties to artists.

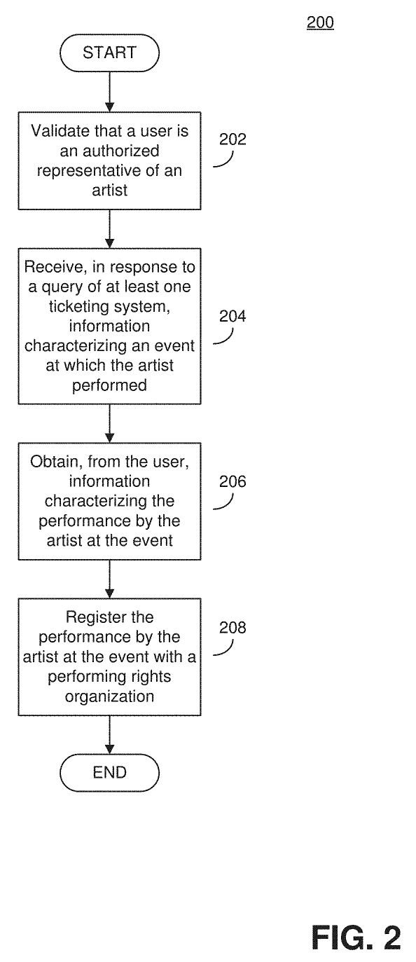

FIG. 2 illustrates an example process flow 200 for reporting an event, performed by an artist, to a performing rights organization. In some embodiments, the process flow 200 may be executed by at least one performance registration system, for example the at least one performance registration system 120 of FIG. 1.

The process flow 200 may include a step 202, in which the at least one performance registration system may validate that a user is an authorized representative of the artist. The at least one performance registration system may itself validate that the user is an authorized representative of the artist, or receive, from an external source, validation that the user is an authorized representative of the artist. In some embodiments, there may exist an enrollment process by which the user may validate their identity (e.g., the user is the artist or is a representative of the artist). For example, in some embodiments, the user may create an artist profile during the enrollment process. In an embodiment where the at least one performance registration system itself validates that the user is an authorized representative of the artist, the user may create an artist profile associated with the at least one performance registration system. In an embodiment where the at least one performance registration system receives, from an external source, validation that the user is an authorized representative of the artist, the user may create an artist profile associated with the external source. In such an embodiment, the external source may be Facebook®, and the user may be affiliated with a Facebook® page associated with the artist.

While creating the artist profile, the user may provide identification information to validate that the user is the artist or the representative of the artist. For example, the user may provide at least one email address, at least one phone number, and other identification information, and the user may be contacted to confirm that the user is the artist or the representative of the artist. Additionally, as may be the case in an embodiment where an artist profile is associated with Facebook®, the artist profile may be confirmed as the official profile of the artist by other Facebook® users. The user may be asked to link an artist profile associated with the at least one performance registration system with the official artist profile on Facebook®, which may require the user to know login credentials for the official artist profile on Facebook®. Alternatively, as may be the case in an embodiment where an artist profile is associated with the at least one performance registration system, the artist profile may be confirmed as the office profile of the artist by other users of the at least one performance registration system.

In this way, the at least one performance registration system may confirm that the user is an authorized representative of the artist.

The process flow 200 may then include a step 204, in which the at least one performance registration system may receive, in response to a query of at least one ticketing system, information characterizing the event at which the artist performed. In some embodiments, as described in connection with FIG. 1, the at least one performance registration system may be configured to query at least one computing device associated with the at least one ticketing system to provide the information characterizing the event. As described above, the information characterizing the event may include at least: a location of the event, a date of the event, a time of the event, a type of venue at which the artist performed (e.g., a festival or a pop-up concert), a type of the event, a price of a ticket to the event, a number of tickets sold, gross ticket sales, which artists are performing at the event, the order in which the artists performed (e.g., which artist headlined an event, and which artist(s) opened for the headliner), a full set list including all works performed by the artists and artists who originally created or contributed to such works (e.g., composers for songs), information regarding a promoter of the event (e.g., identity of the promoter, address and phone number of the promoter), contracts for each artist, physical proof of the ticket (e.g., a picture of a ticket stub), as well as other information.

The process flow 200 may then include a step 206, in which the at least one performance registration system may obtain, from the user, information characterizing the performance by the artist at the event. In some embodiments, the at least one performance registration system may be configured to send a prompt to the user, prompting the user to provide the information characterizing the performance by the artist. As described in connection with FIG. 1, the at least one performance registration system may send the prompt through at least one messaging system, to at least one messaging application on a communication device (e.g., a phone or a computer) of the user, and the communication device may display the prompt to the user. The communication device may be configured to allow the user to provide the information characterizing the performance by the artist. In some embodiments, the information characterizing the performance by the artist may include works that were performed by the artist at the event.

The process flow 200 may then include a step 208, in which the at least one performance registration system may register the performance by the artist at the event with the performing rights organization. The at least one performance registration system may register the performance by the artist at the event with the PRO at least by sending the information characterizing the event and the information characterizing the performance by the artist to the PRO. In doing so, the at least one performance registration system may be able to register the performance by the artist at the event with the PRO and ensure that all information provided to the PRO is validated. Thus, the PRO may quickly and efficiently process the performance by the artist at the event and distribute appropriate royalties.

It should be appreciated that the process of FIG. 2 is merely illustrative, and that other embodiments are possible. As discussed above, in some alternative embodiments, a process like the process 200 of FIG. 2 may not include a step of retrieving from a ticketing system information characterizing an event. This may be done, for example, with informal or less formal events that may not be registered with a ticketing system, such as events for which tickets are sold exclusively at the venue or for which tickets are not sold (e.g., free events). Such informal events may include impromptu events that are not held at professional venues, but which may still qualify as public performances and for which royalties are owed.

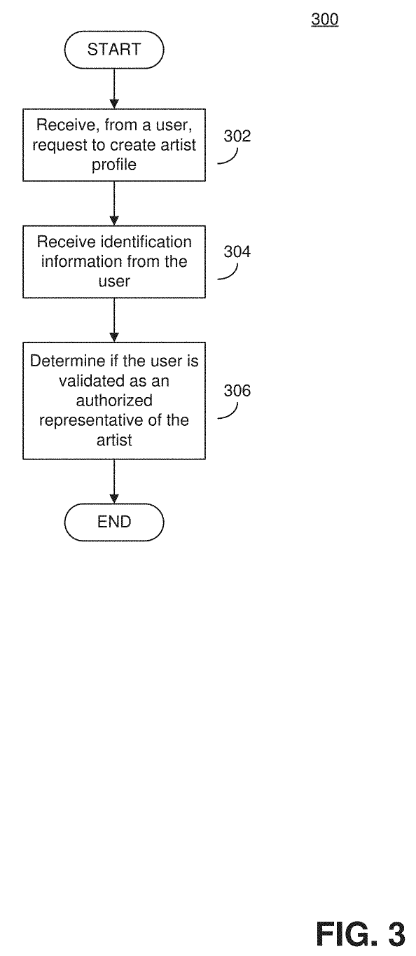

FIG. 3 illustrates an example process flow 300 for validating that a user is an authorized representative of an artist. In some embodiments, the process flow 300 may be executed by at least one performance registration system, for example the at least one performance registration system 120 of FIG. 1.

The process flow 300 may include a step 302, in which the at least one performance registration system receives a request from the user to create an artist profile. In some embodiments, the artist profile may allow the user to manage content relating to the artist (e.g., images of the artist, links to social media, etc.). The artist profile may also allow the user to update content relating to the artist in real time.

The process flow 300 may then include a step 304, in which the at least one performance registration system receives identification information from the user. In some embodiments, the at least one performance registration system may require the user to connect the artist profile, associated with the performance registration system, with an external artist profile. For example, the at least one royalty may require the user to connect the artist profile with an artist profile from Facebook®. There may be an official artist profile on Facebook® for the artist, and connecting the artist profile associated with the at least one performance registration system with the official artist profile on Facebook® may ensure the validity of the user as a representative of the artist. In such an embodiment, the artist profile associated with the at least one performance registration system may be created using the URL of the official artist profile on Facebook®.

In another embodiment, the at least one performance registration system may require the user to provide other identification information (e.g., at least one email address, at least one phone number, etc.). The at least one performance registration system may contact, via the at least one email address and/or the at least one phone number, the artist (e.g., members of a band, or a manager of the band) to confirm that the user is indeed a representative of the artist.

In another embodiment, the at least one performance registration system may use location data of the user to confirm that the user is a representative of the artist. For example, if an artist is on tour and has recently played at events in Nashville, New York, and Las Vegas, the at least one performance registration system may access location data of the user to confirm that the user's past locations are consistent with the artist's tour.

In another embodiment, there may be an organization that is known for representing artists (e.g., Creative Artists Agency). The organization may already have multiple artist profiles for other artists. If the user provides, for example, an email address associated with an organization known for representing artists, the at least one performance registration system may confirm that the user is a representative of the artist.

In another embodiment, the at least one performance registration system may employ a crowdsourcing service (e.g., Mechanical Turk) to confirm that the user is the artist or a representative of the artist. For example, the at least one performance registration system may request that a crowdsourcing service confirm that images, or information associated with the artist, submitted on the artist profile are consistent with images on the official artist page on Facebook®. If the content submitted on the artist profile is consistent with the official artist page, this may be a factor that weighs in favor of (but, in some embodiments, may not be definitive) the user being a legitimate representative of the artist.

The process flow 300 may then include a step 306, in which the at least one performance registration system determines if the user is validated as an authorized representative of the artist. In an embodiment in which the user is required to connect the artist profile associated with the at least one performance registration system with an external artist profile (e.g., official artist profile on Facebook®), the at least one performance registration system may determine that the user is validated as an authorized representative of the artist if the user is able to connect the artist profile with the external artist profile. In an embodiment in which the user is required to provide other identification information, the at least one performance registration system may determine that the user is validated as a representative of the artist if, after contacting the artist, the artist confirms that the user is a representative of the artist. Alternatively, other users of the at least one performance registration system may confirm that the artist page is an official artist page of the artist, and the at least one performance registration system may validate that the user is a representative of the artist at least from this confirmation.

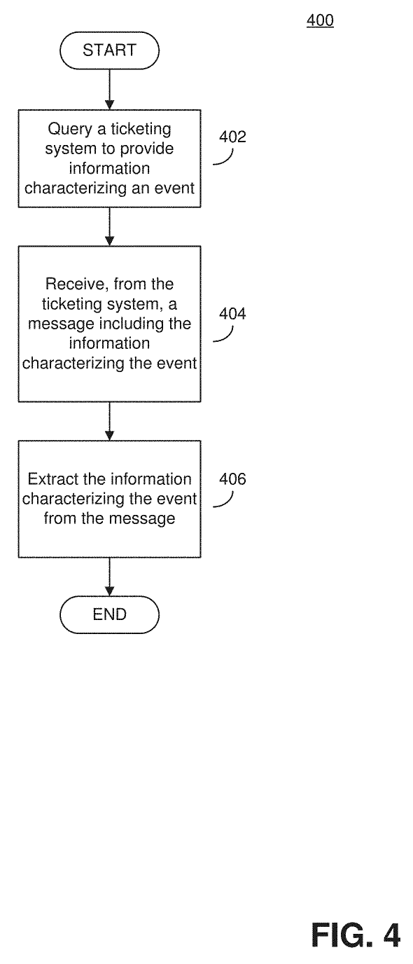

FIG. 4 illustrates an example process flow 400 for obtaining, from at least one ticketing system, information characterizing an event. In some embodiments, the process flow 400 may be executed by at least one performance registration system, for example the at least one performance registration system 120 of FIG. 1. The process flow 400 may be executed by the at least one performance registration system to obtain, from the at least one ticketing system, information characterizing an event before the event occurs. Alternatively, the process flow 400 may be executed by the at least one performance registration system to obtain, from the at least one ticketing system, information characterizing an event during or after the event occurs.

The process flow 400 may include a step 402, in which the at least one performance registration system may query the at least one ticketing system to provide the information characterizing the event. In some embodiments, as described in connection with FIG. 1, the at least one ticketing system may be associated with a ticket sales and distribution company (e.g., Ticketmaster® or Eventbrite®). The at least one ticketing system may be configured to transact with attendees of an event at which an artist performed to provide tickets to the event, and to store information regarding the event. For example, the at least one ticketing system may be configured to store, at least: a location of the event, a date of the event, a time of the event, a type of venue at which the artist performed (e.g., a festival or a pop-up concert), a type of the event, a price of a ticket to the event, a number of tickets sold, gross ticket sales, which artists are performing at the event, the order in which the artists performed (e.g., which artist headlined an event, and which artist(s) opened for the headliner), a full set list including all works performed by the artists and an identification of artists who originally created or contributed to such works (e.g., composers for songs), information regarding a promoter of the event (e.g., identity of the promoter, address and phone number of the promoter), contracts for each artist, physical proof of the ticket (e.g., a picture of a ticket stub), as well as other information. In some embodiments, only some of the foregoing information may be stored by and accessible from a ticketing system, and in some such embodiments some of the information may not be obtained by the performance registration system or may be obtained from other sources, such as from a user. In other embodiments, as discussed above, a ticketing system may not be used for an event and information characterizing an event may not be obtained from a ticketing system.

The process flow 400 may then include a step 404, in which the at least one performance registration system may receive, from the at least one ticketing system, a message including the information characterizing the event. The query of the at least one ticketing system, and the message from the at least one ticketing system, may be transmitted over a communication network, for example the communication network 110 of FIG. 1.

The process flow 400 may then include a step 406, in which the at least one performance registration system may extract the information characterizing the event from the message. As discussed in connection with FIG. 1, different ticket sales and distribution companies may store the information characterizing the event differently, and may send the information characterizing the event to the at least one performance registration system in a different format. As such, the at least one performance registration system may be configured to extract the information characterizing the event from a plurality of different formats. Such extraction may be performed in a variety of manner, depending on the format of the received information, and may include a rules-based extraction (e.g., looking for content that is structured or worded in a manner that satisfies a condition, and extracting located content) or natural language processing. The at least one performance registration system may then be configured to organize the information characterizing the event in a format recognizable by a PRO system to which the information characterizing the event will be sent. This may be advantageous as it may prevent the PRO system from needing to reformat data received in a royalty request, and thus streamline the process of registering events performed by artists and distributing royalties.

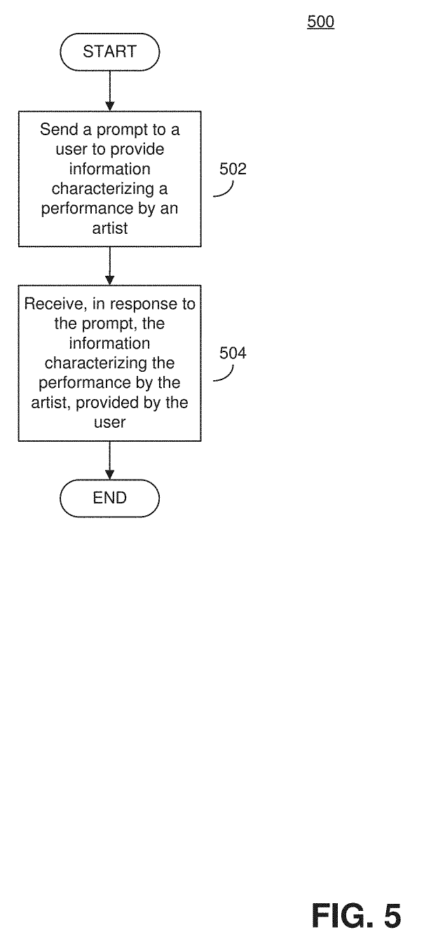

FIG. 5 illustrates an example process flow 500 for obtaining, from a user, information characterizing a performance by an artist at an event. In some embodiments, the process flow 500 may be executed by at least one performance registration system, for example the at least one performance registration system 120 of FIG. 1.

The process flow 500 may include a step 502, in which the at least one performance registration system may send a prompt to the user to provide the information characterizing the performance by the artist. In some embodiments, the information characterizing the performance by the artist may include works that were performed by the artist at the event. The prompt may be sent to a communication device (e.g., a phone or a computer) of the user, and the communication device may display the prompt to the user. The at least one performance registration system may be configured to communicate with the user via a messaging application. The messaging application may be associated with a messaging system external to the at least one performance registration system (e.g. Facebook®), or may be associated with a messaging system that is included in the at least one performance registration system.

The process flow 500 may then include a step 504, in which the at least one performance registration system may receive, in response to the prompt, the information characterizing the performance by the artist, provided by the user. The communication device on which the prompt is displayed may allow the user to provide the information characterizing the performance by the artist. For example, the communication device may include a touch screen, on which a list of some or all of the artist's works may be displayed. The works that are displayed may include The communication device may allow the user to, using the touch screen, select the works that were performed by the artist at the event. In some embodiments, the at least one performance registration system may be configured to send the prompt to the user, prompting the user to provide the information characterizing the performance by the artist, after the event has occurred. For example, in some embodiments, the at least one performance registration system may be configured to send the prompt to the user a certain number of hours after the event (e.g., 12 hours after the event), or to send the prompt to the user at a certain time of day (e.g., at LOAM the day after the event).

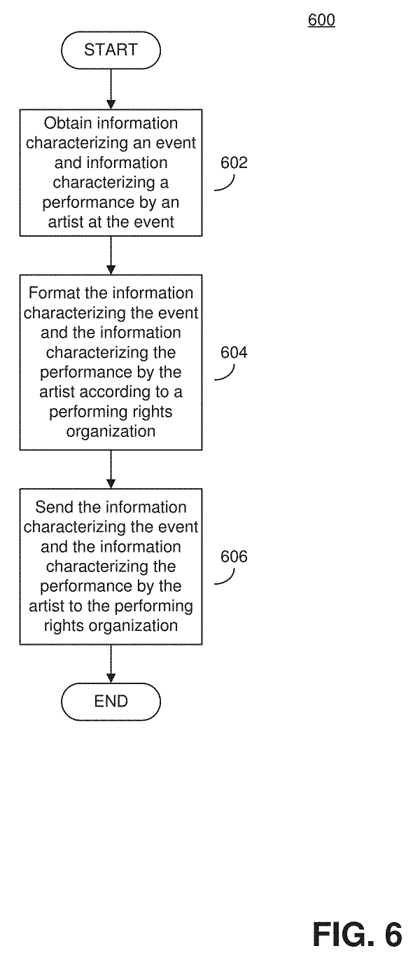

FIG. 6 illustrates an example process flow 600 for registering a performance by an artist at an event with a performing rights organization. In some embodiments, the process flow 600 may be executed by at least one performance registration system, for example the at least one performance registration system 120 of FIG. 1.

The process flow 600 may include a step 602, in which the at least one performance registration system may obtain information characterizing an event and information characterizing a performance by an artist at the event. For example, the at least one performance registration system may obtain the information characterizing the event and the information characterizing the performance by the artist at the event as described in connection with FIG. 1, and according to the process flows 400 and 500 described in connection with FIG. 4 and FIG. 5, respectively.

The process flow 600 may then include a step 604, in which the at least one performance registration system may format the information characterizing the event and the information characterizing the performance by the artist at the event according to a PRO. The at least one performance registration system may be configured to send the information characterizing the event and the information characterizing the performance by the artist at the event to a plurality of PROs, and each PRO may expect the information characterizing the event and the information characterizing the performance by the artist in different formats. The at least one performance registration system may be configured to send the information characterizing the event and the information characterizing the performance by the artist at the event in a plurality of formats, and configured to send the information characterizing the event and the information characterizing the performance by the artist at the event in a format appropriate for the specific PRO.

In some embodiments, different PROs may use, in determining whether and/or how to distribute royalties for a performance at an event, different sets of information characterizing an event and/or different sets of information characterizing a performance by the artist. For example, one PRO may require a piece of information (e.g., the gender of a promoter for the event) to distribute royalties, while a second PRO may not require the additional piece of information. In such an embodiment, the at least one performance registration system may be configured to obtain the additional piece of information in response to determining that the first PRO is the PRO to which the royalty request is being submitted. For example, the performance registration system may prompt a user for the needed information.

In some embodiments, different PROs may expect the information characterizing the event and/or information characterizing the performance by the artist to be sent in a specific manner, for example in a specific type of file. For example, different PROs may expect the information characterizing the event and/or information characterizing the performance by the artist to be contained in a spreadsheet, contained in an XML file, uploaded via an API of the PRO, sent by email, or other manners to send the information characterizing the event and/or the information characterizing the performance by the artist. The at least one performance registration system may be configured to send the information characterizing the event and/or the information characterizing the performance by the artist in the specific manner required by a PRO to which the royalty request is being submitted.

The process flow 600 may then include a step 606, in which the at least one performance registration system may send the information characterizing the event and the information characterizing the performance by the artist at the event to the PRO. In this way, the at least one performance registration system may register the performance by the artist at the event with the PRO, and the PRO may then be able to distribute royalties appropriately.

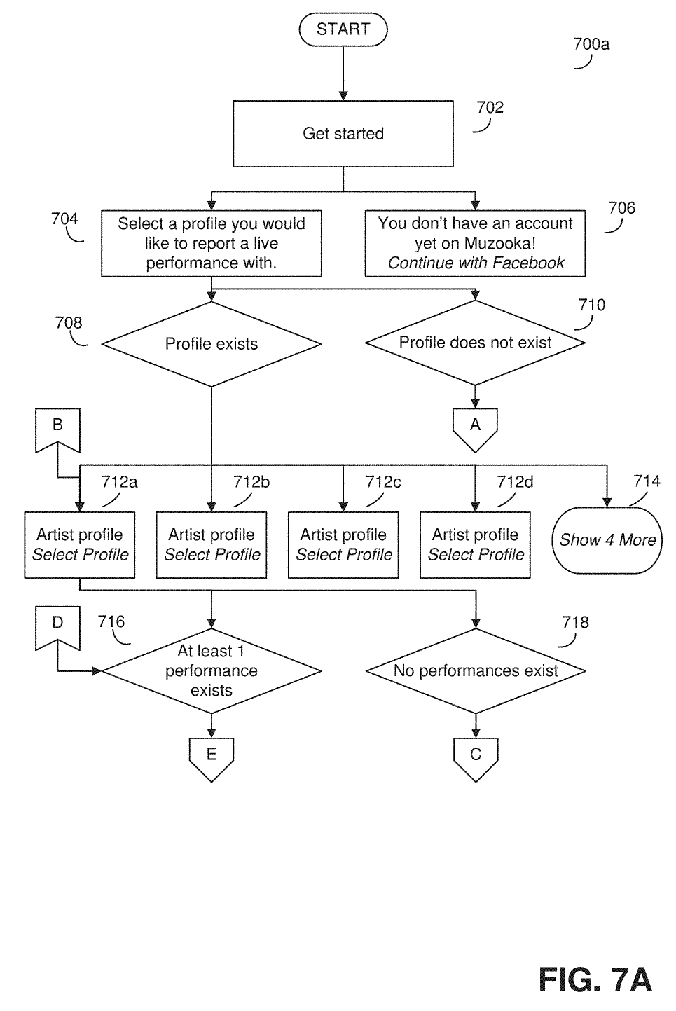

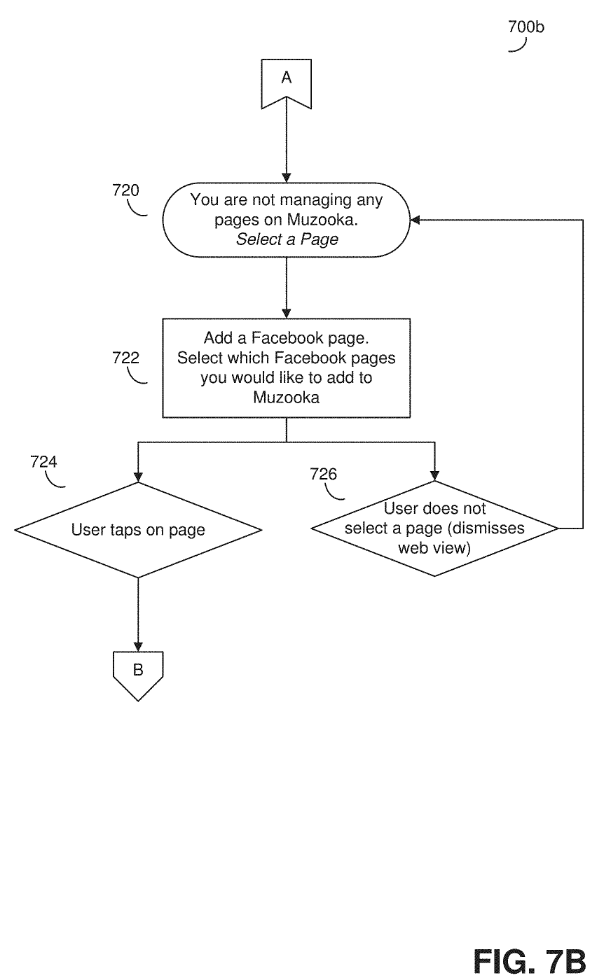

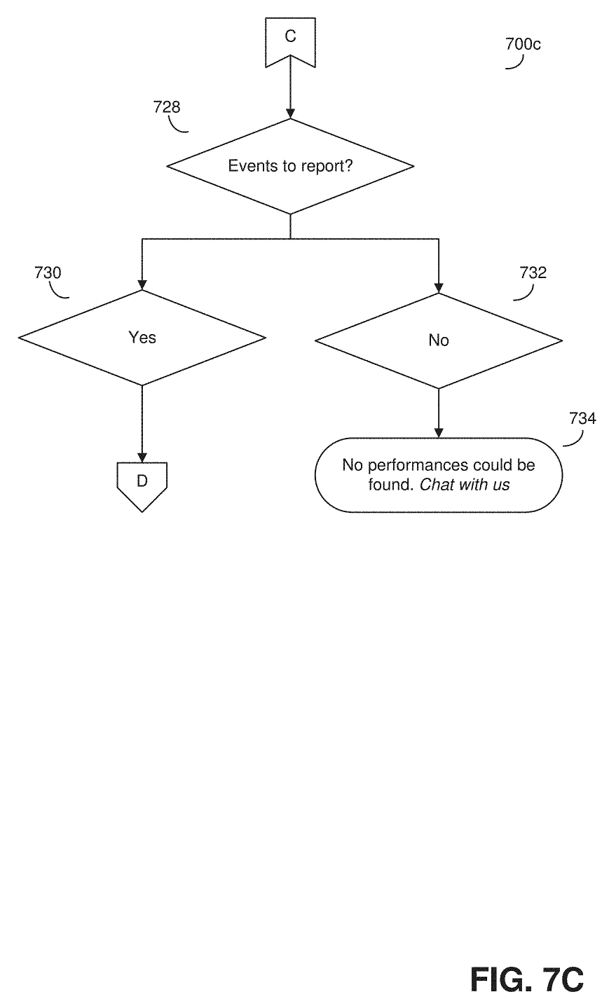

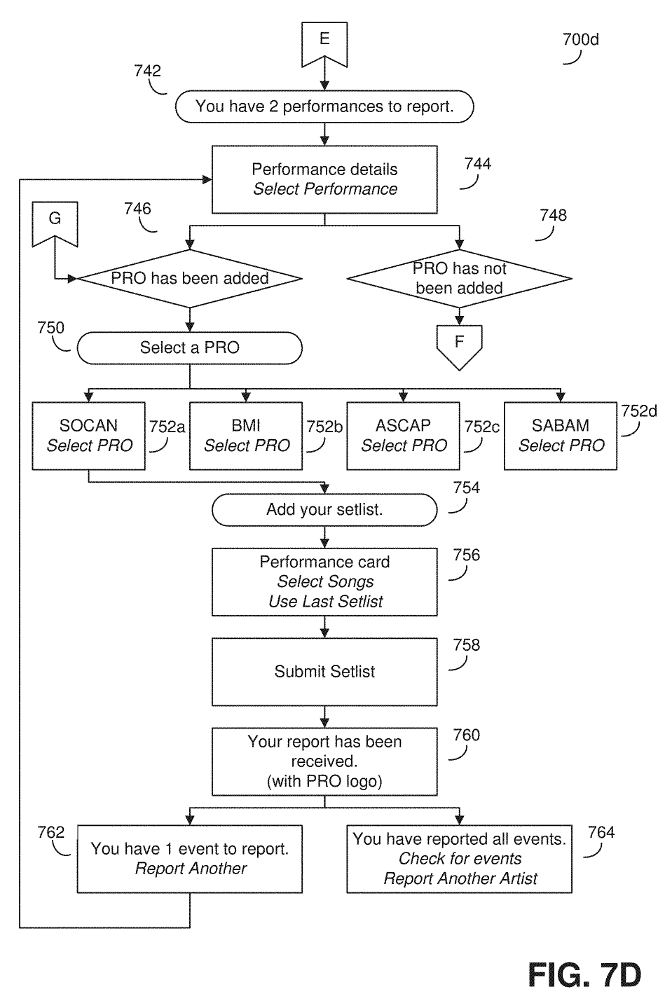

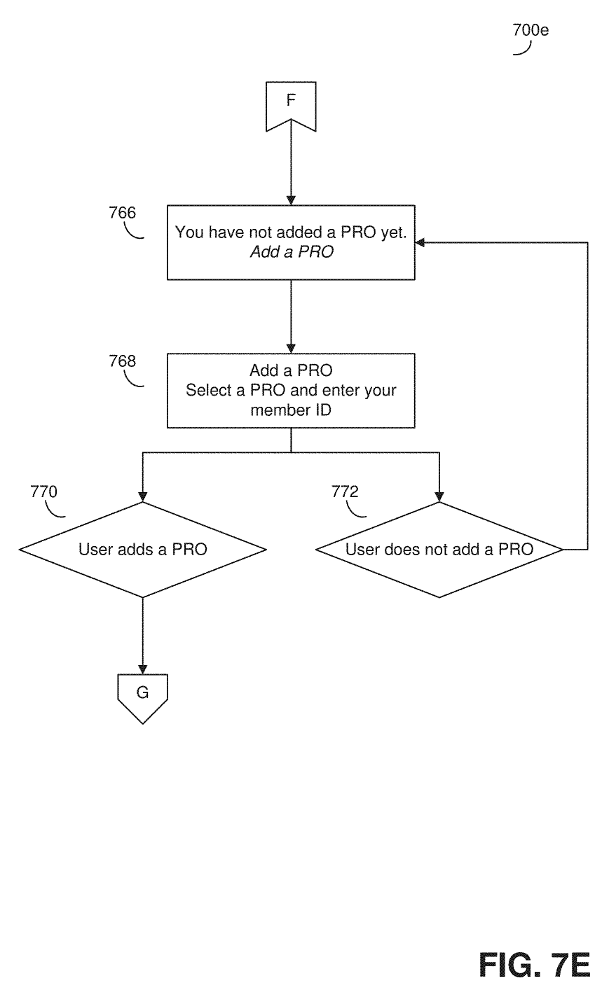

FIGS. 7A-7E together illustrate example logic flow chart portions 700a-700e for communicating with a user via a messaging application to obtain information characterizing a performance by an artist at an event. In some embodiments, the logic flow chart portions 700a-700e may be executed by at least one performance registration system through a messaging application, for example the at least one performance registration system 120 of FIG. 1. As described above, the user may be able to communicate with the at least one performance registration system and provide the information characterizing the performance by the artist within the messaging application on a communication device (e.g., a phone or a computer).

According to the logic flow chart portion 700a shown in FIG. 7A, the user may first be presented with a starting indication or selection at step 702. The user may then prompted to select a profile from which the user would like to report a live performance at step 704. For example, step 704 may be performed when the user already has a profile from which they manage artist profiles. The profile may be associated with the at least one performance registration system, or may be associated with a system external to the at least one performance registration system (e.g., Facebook®). If such a profile does not exist, the user may be prompted to create a profile at step 706. The user may be prompted to create a profile with the at least one performance registration system, or may be prompted to create a profile on the system external to the at least one performance registration system.

In some embodiments, if a profile exists at step 708, the user may then be able to select the artist profile for which they would like to report a live performance at step 712a-712d. The user may be associated with a plurality of artists (e.g., the user is part of an organization that represents many artists), and the user may be able to select which artist profile they would like to report the live performance. The user may select an option to display more artists at step 714.

In some embodiments, if a profile does not exist at step 710, the user may add a profile under logic flow chart portion 700b shown in FIG. 7B. The user may be presented with an indication that the user does not have any associated profiles at step 720. The user may be allowed to add profiles at step 722. If the user adds a profile at step 724, the user may be directed to the profile at step 712a. If the user does not add a profile at step 726, the user may be returned to the indication that the user does not have any associated profiles at step 720.

In some embodiments, when a profile is selected at step 712a, if no performances exist for the user at step 718, performances may be checked for under logic flow chart portion 700c shown in FIG. 7C. A check on whether there are events for the artist to report may be made at step 728. If it is determined at step 732 that there are not, an indication may be presented to the user that events were not found at step 734. Step 736 may allow a user to select an option to chat with a representative. If, however, at step 730 it is determined that there are events to report, processing may continue with a process for reporting an event/performance.

In some embodiments, if a performance exists for the user at step 716 or 730, the user may report a performance under logic flow chart portion 700d shown in FIG. 7D. The user may then be notified if there exists a performance by the artist associated with the selected artist profile for which the user must report at step 742. For example, after an event occurs at which the artist performed, the event may appear under the artist profile as a performance for which the user must report. If no performances exist for which the user must report, the user may be informed that this is the case at step 718, and the user may be able to select another artist profile for which to report a performance.

If there exists a performance for which the user must report, the user may be able to see details relating to the performance at step 744. For example, the user may be displayed information characterizing the event, such as the venue location and the name of the event. The user may be able to select the performance to report the information characterizing the performance by the artist at step 744.

After the user has selected the performance on which to report, the at least one performance registration system may determine if a PRO is associated with the performance. If there are no PROs associated with the performance at step 748, the user may be prompted to add a PRO for the performance under logic flow chart portion 700e shown in FIG. 7E. The user may be provided with an indication that there are no associated PROs at step 766. The user may be allowed to add a PRO at step 768. If the user adds a PRO at step 770, the user may be directed to the indication that a PRO has been added at step 746. If the user does not add a PRO at step 772, the user may be returned to the indication that are no associated PROs at step 766.

If a PRO is associated with the performance, the user may select at least one PRO associated with the performance from which the user would like to request royalties at step 750. For example, there may be a plurality of PROs associated with the performance (e.g., SOCAN, BMI, ASCPA, and SABAM), and the user may select at least one PRO of the plurality of PROs from which to request royalties at steps 752a-752d.

After the user has selected the PROs from which to request royalties, the user may be prompted to provide a setlist at step 754, which may include works performed in the performance. The user may then be displayed options for the performance at step 756, such as displaying the setlist, and the user may be able to select the works that the artist performed at the event. In some embodiments, the at least one performance registration system may already have stored a setlist (e.g., a prior setlist), and the user may be automatically displayed the setlist from which the user may select the works that the artist performed at the event.

The user may then be able to review the selected works, and then submit the setlist at step 758. The at least one performance registration system may receive the selected works, and send an identification of the selected works, along with information characterizing the event, to the PROs that the user selected. As discussed, the at least one performance registration system may format the selected works (the information characterizing the performance by the artist) and the information characterizing the event according to an expected format of each of the selected PROs.

The user may then be displayed a notice confirming that the royalty request has been received at step 760. The notice may contain a logo of each of the selected PROs. The user may then be able to select another event for which to report according to the selected artist profile at step 762. If all events for artist are reported at step 764, the user may be able to check for events, or may be able to switch to a different artist profile for which to report events.

In some embodiments, the user may be able to provide information characterizing the performance by the artist in various manners. In one embodiment, the communication device may include a touch screen, and the user may be able to provide information characterizing the performance by the artist by physically selecting items displayed on the touch screen. In another embodiment, the user may be able to provide a text input to the at least one performance registration system, for example with a keyboard. In such an embodiment, the user may be able to type in the works that the artist performed at the event. In such an embodiment, the at least one performance registration system may process text input provided by the user to determine the works that the artist performed at the event. In another embodiment, the user may be able to upload a file including the works that the artist performed at the event. For example, the user may upload a file that includes information on works performed. An example of such a file that may be uploaded is a CSV file or file in another format that is generated from a disc jockey (DJ) platform that indicates information on works that were played by the platform during a performance. The file may be uploaded by a user to the at least one performance registration system, and the at least one performance registration system may forward the file, as received, to a PRO as part of a registration request, or may process the file to determine the works that the artist performed at the event and include the identified works in the registration request. In another embodiment, the at least one performance registration system may utilize natural language understanding (NLU) processing, and the user may be able to provide input by speaking the works that the artist performed at the event. In such an embodiment, the at least one performance registration system may process the voice input, such as using automatic speech recognition (ASR), provided by the user to determine the works that the artist performed at the event. In other embodiments, the at least one performance registration system may additionally or alternatively receive a input an image that includes text identifying works performed in a performance by an artist. The image may be processed, such as using a text recognition technique like optical character recognition (OCR) or handwriting recognition techniques, to generate text identifying works performed. In embodiments in which such a processing of input speech or an image is performed, the speech or text recognition may be constrained using a list of registered works of an artist and/or works previously performed by an artist. For example, a grammar may be created that includes the titles of works that an artist has previously registered with a PRO, which may have been retrieved form the PRO as described above. By generating a grammar in this manner, the speech or text processing may be constrained to identifying a match between input speech or image text and a registered work, which may increase the likelihood of a match being determined as compared to embodiments that do not create such a focused grammar.

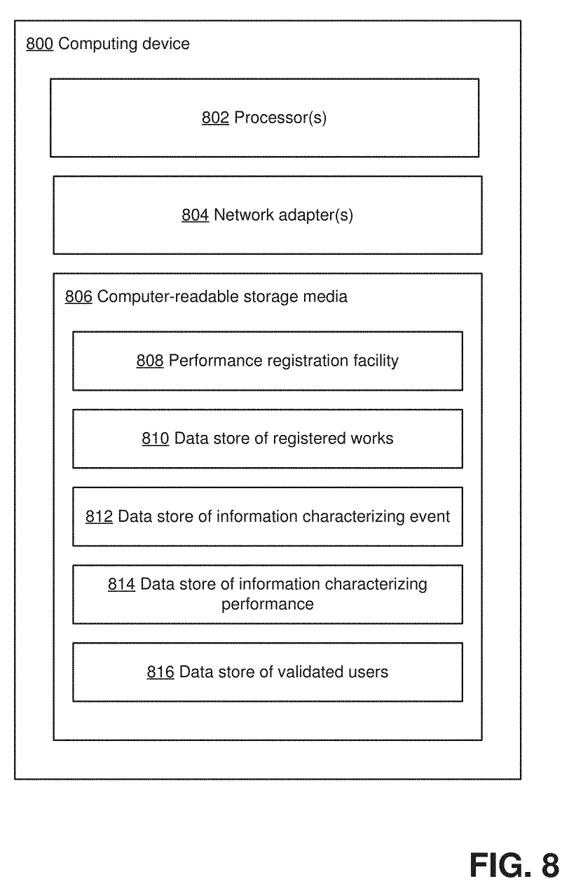

FIG. 8 illustrates an embodiment of a computing device 800 as described herein, for example for reporting an event, performed by an artist, to a PRO. In one embodiment, the computing device 800 may include at least one processor(s) 802 and at least one network adapter(s) 804. The computing device may also include computer readable storage media 806 which may include an alignment assistance facility module 808, a current alignment module 810, a correct alignment module 812, a position of sensors module 814, and an impact of adjustment tool module 816. The computing device 800 may be designed to receive information characterizing the event and information characterizing the performance by the artist, and to register the performance by the artist at the event to the PRO.

Techniques operating according to the principles described herein may be implemented in any suitable manner. Included in the discussion above are a series of flow charts showing the steps and acts of various processes performed by the computing device 800. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 806 of FIG. 8 described above (i.e., as a portion of a computing device 800) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 8, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing devices sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

FIG. 8 illustrates one exemplary implementation of a computing device in the form of a computing device 800 that may be used in a system implementing techniques described herein, although others are possible. It should be appreciated that FIG. 8 is intended neither to be a depiction of necessary components for a computing device to obtain the information characterizing the event and information characterizing the performance by the artist and register the performance by the artist at the event with the PRO in accordance with the principles described herein, nor a comprehensive depiction.

Computing device 800 may comprise at least one processor 802, a network adapter 804, and computer-readable storage media 806. Computing device 800 may be, for example, a desktop or laptop personal computer, a personal digital assistant (PDA), a smart mobile phone, a server, a wireless access point or other networking element, or any other suitable computing device. Network adapter 804 may be any suitable hardware and/or software to enable the computing device 800 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable storage media 806 may be adapted to store data to be processed and/or instructions to be executed by processor 802. Processor 802 enables processing of data and execution of instructions. The data and instructions may be stored on the computer-readable storage media 806 and may, for example, enable communication between components of the computing device 800.

The data and instructions stored on computer-readable storage media 806 may comprise computer-executable instructions implementing techniques which operate according to the principles described herein. In the example of FIG. 8, computer-readable storage media 806 stores computer-executable instructions implementing various facilities and storing various information as described above. Computer-readable storage media 806 may store computer-executable instructions for receiving the information characterizing the event and information characterizing the performance by the artist, and registering the performance by the artist at the event to the PRO. The instructions may include a performance registration facility 808, which may perform any of, any combination of, or all of, the functionality described above as being performed by a performance registration system. The information stored on computer-readable storage media 806 may further include a data store 810 of registered works, a data store 812 of information characterizing one or more events, a data store 814 of information characterizing one or more performances, and a data store 816 of validated users. At least some of the information in data stores 810-816 may have been retrieved by the performance registration facility from one or more validated data sources, as discussed above.

While not illustrated in FIG. 8, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Further, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A method of reporting an event, performed by an artist, to a performing rights organization, the method comprising:
validating that a user is an authorized representative of the artist;
receiving, in response to a query of at least one computing device associated with at least one ticketing system, a first set of information characterizing the event, the at least one ticketing system each transacting with attendees of the event to provide tickets to the event, the first set of information comprising a type of event, a venue of the event, at least one ticket price for the event, and an identification of one or more promoters of the event;
obtaining, from the user, a second set of information characterizing the performance by the artist at the event, wherein the second set of information comprises an identification of one or more songs performed by the artist at the event; and
registering the performance by the artist at the event with the performing rights organization, wherein the registering comprises sending to the performing rights organization at least some of the first set of information characterizing the event and at least some of the second set of information characterizing the performance by the artist at the event.

2. The method of claim 1, wherein validating that the user is the authorized representative of the artist comprises:
obtaining from the user login credentials for an account with a social network from the user; and
confirming that the social network associates the account with the artist.

3. The method of claim 1, wherein receiving the first set of information characterizing the event comprises:
polling the at least one ticketing system at a regular interval for information regarding events for which the at least one ticketing system stores information, the events comprising the event.

4. The method of claim 1, wherein obtaining the second set of information characterizing the performance by the artist at the event comprises:
obtaining from at least one second computing device a purported list of the one or more songs performed by the artist at the event, the purported list having been contributed at least in part by attendees of the event;
sending a prompt to the user to input the identification of the one or more songs, the prompt comprising the purported list and prompting the user to confirm or edit the purported list.

5. The method of claim 1, wherein obtaining the second set of information characterizing the performance by the artist at the event comprises presenting, via an automated dialog system, in a dialog with the user, wherein engaging with the dialog with the user comprises:
prompting the user with a sequence of a plurality of prompts, each prompt of the plurality of prompts prompting the user to input information regarding the event; and
in response to each prompt of the plurality of prompts, interpreting input from the user in response to the prompt.

6. The method of claim 5, wherein engaging in the dialog comprises engaging in a dialog that is at least partially text-based, and wherein interpreting the input comprises performing natural language processing on input provided by the user.

7. The method of claim 5, wherein engaging in the dialog comprises engaging in a dialog that is at least partially speech-based, and wherein interpreting the input comprises performing automatic speech recognition (ASR) on speech input provided by the user.

8. The method of claim 5, wherein:
prompting the user with the sequence of the plurality of prompts comprises presenting at least one prompt that requests the user to select one option from among a plurality of presented options; and
interpreting the input comprises interpreting the input to determine which option from among the plurality of presented options was selected by the user.

9. The method of claim 5, wherein prompting the user with the sequence of the plurality of prompts comprises presenting at least one prompt comprises prompting the user based on the first set of information characterizing the event.

10. The method of claim 9, wherein prompting the user based on the first set of information characterizing the event comprises, in response to receiving a request from the user to report an event,
determining one or more artists for which the user has been validated as representative,
determining one or more events in which information from the at least one ticketing system indicates the artist is performing, will perform, or performed, the one or more events including the event,
prompting the user to select an event from among the one or more events that the user is to report to the performing rights organization;
in response to selection by the user of the event, prompting the user to input the second set of information characterizing the performance.

11. The method of claim 10, wherein prompting the user to input the second set of information characterizing the performance comprises:
determining one or more previously-performed songs performed by the artist at one or more prior events; and
prompting the user to input the one or more songs at least in part by selecting the one or more songs performed by the artist at the event from among a list of the one or more previously-performed songs.

12. The method of claim 10, wherein prompting the user to input the second set of information characterizing the performance comprises:
determining one or more registered songs of the artist registered with the performing rights organization; and
prompting the user to input the one or more songs at least in part by selecting the one or more songs performed by the artist at the event from among a list of the one or more registered songs.

13. The method of claim 1, further comprising:
in response to determining that at least some of the one or more songs performed by the artist at the event are registered with a second performing rights organization, additionally registering the performance by the artist at the event with the second performing rights organization, wherein the registering comprises sending to the second performing rights organization at least some of the first set of information characterizing the event and at least some of the second set of information characterizing the performance by the artist at the event.

14. At least one non-transitory computer-readable storage medium encoded with executable instructions that, when executed by at least one processor, cause the at least one processor to carry out a method of reporting an event, performed by an artist, to a performing rights organization, the method comprising:
validating that a user is an authorized representative of the artist;
receiving, in response to a query of at least one computing device associated with at least one ticketing system, a first set of information characterizing the event, the at least one ticketing system each transacting with attendees of the event to provide tickets to the event;
obtaining, from the user, a second set of information characterizing the performance by the artist at the event, wherein the second set of information comprises an identification of one or more songs performed by the artist at the event; and
registering the performance by the artist at the event with the performing rights organization, wherein the registering comprises sending to the performing rights organization at least some of the first set of information characterizing the event and at least some of the second set of information characterizing the performance by the artist at the event.

15. The at least one computer-readable storage medium of claim 14, wherein validating that the user is the authorized representative of the artist comprises:
obtaining from the user login credentials for an account with a social network from the user; and
confirming that the social network associates the account with the artist.

16. The at least one computer-readable storage medium of claim 14, wherein obtaining the second set of information characterizing the performance by the artist at the event comprises presenting, via an automated dialog system, in a dialog with the user, wherein engaging with the dialog with the user comprises:
prompting the user with a sequence of a plurality of prompts, each prompt of the plurality of prompts prompting the user to input information regarding the event; and
in response to each prompt of the plurality of prompts, interpreting input from the user in response to the prompt.

17. The at least one computer-readable storage medium of claim 16, wherein prompting the user with the sequence of the plurality of prompts comprises presenting at least one prompt comprises prompting the user based on the first set of information characterizing the event.

18. An apparatus comprising:
at least one processor; and
at least one computer-readable storage medium encoded with executable instructions that, when executed by the at least one processor, cause the at least one processor to carry out a method of reporting an event, performed by an artist, to a performing rights organization, the method comprising:
validating that a user is an authorized representative of the artist;
receiving, in response to a query of at least one computing device associated with at least one ticketing system, a first set of information characterizing the event, the at least one ticketing system each transacting with attendees of the event to provide tickets to the event;
obtaining, from the user, a second set of information characterizing the performance by the artist at the event, wherein the second set of information comprises an identification of one or more songs performed by the artist at the event; and
registering the performance by the artist at the event with the performing rights organization, wherein the registering comprises sending to the performing rights organization at least some of the first set of information characterizing the event and at least some of the second set of information characterizing the performance by the artist at the event.

19. The apparatus of claim 18, wherein obtaining the second set of information characterizing the performance by the artist at the event comprises:
obtaining from at least one second computing device a purported list of the one or more songs performed by the artist at the event, the purported list having been contributed at least in part by attendees of the event;
sending a prompt to the user to input the identification of the one or more songs, the prompt comprising the purported list and prompting the user to confirm or edit the purported list.

20. The apparatus of claim 18, wherein obtaining the second set of information characterizing the performance by the artist at the event comprises presenting, via an automated dialog system, in a dialog with the user, wherein engaging with the dialog with the user comprises:
prompting the user with a sequence of a plurality of prompts, each prompt of the plurality of prompts prompting the user to input information regarding the event; and
in response to each prompt of the plurality of prompts, interpreting input from the user in response to the prompt.
